(19) United States
(12) Patent Application Publication
(10) Pub. No.: US 2024/0280277 A1
(43) Pub. Date: Aug. 22, 2024

(54) BUILDING AIR VENTILATION SYSTEMS AND METHODS

(71) Applicant: WILD CAT TEAM LTD., Edmonton (CA)

(72) Inventors: Ronny Neufeld, Edmonton (CA); Peter Neufeld, Edmonton (CA)

(21) Appl. No.: 18/419,960

(22) Filed: Jan. 23, 2024

(30) Foreign Application Priority Data
Jan. 24, 2023 (CA) 3,187,396

(51) Int. Cl. F24F 5/00; F24F 12/00; F24F 110/10; F24F 110/12

(52) U.S. Cl. CPC F24F 5/0046; F24F 12/001; F24F 2005/0057; F24F 2110/10; F24F 2110/12

(57) ABSTRACT

An air ventilation system for geothermal heating and cooling of an interior of a building, has piping that includes: an outdoor air inlet; a geothermal ground loop embedded in earth below a ground surface adjacent or below the building and having a ground supply line and a ground return line; a flow control device in the piping; a bridge line between the ground supply line and the ground return line; a building supply line connected to the ground return line and configured to distribute air throughout the interior of the building; a building return line configured to return air from the building; and an exhaust air outlet connected to exhaust air from the building return line.

### TECHNICAL FIELD

This document relates to air ventilation systems and related methods.

### BACKGROUND

The following paragraphs are not an admission that anything discussed in them is prior art or part of the knowledge of persons skilled in the art.

Heat recovery ventilation is used to heat and cool buildings, by using a ventilation unit with a heat pump and a ground heat exchanger.

### SUMMARY

Methods and apparatuses are disclosed comprising cycling air from an outdoor air inlet, through a geothermal ground loop, through an air ventilation system, and out an exhaust air outlet.

An air ventilation system is disclosed for geothermal heating and cooling of an interior of a building, the system comprising piping that includes: an outdoor air inlet; a geothermal ground loop embedded in earth below a ground surface adjacent or below the building and having a ground supply line and a ground return line; a flow control device in the piping; a bridge line between the ground supply line and the ground return line; a building supply line connected to the ground return line and configured to distribute air throughout the interior of the building; a building return line configured to return air from the building; and an exhaust air outlet connected to exhaust air from the building return line.

A method is disclosed comprising: supplying air from an outdoor air inlet to a manifold that feeds both a building air ventilation system and a geothermal ground loop; operating in a ground recirculation mode where recirculation of air is permitted through the geothermal ground loop and into the building air ventilation system; and exhausting air from the building air ventilation system after the air passes through the building.

In various embodiments, there may be included any one or more of the following features: The flow control device comprises a fan. The flow control device is on the ground supply line. The bridge line connects to the ground supply line between the flow control device and the outdoor air inlet. The bridge line, ground supply line, and ground return line form a manifold. The system is configured to cycle air to flow from the outdoor air inlet through the system to adjust an interior air temperature of a building to a target air temperature range. The system is configured to operate in a ground loop recirculation mode in which the flow control device permits air to flow: from the outdoor air inlet, through the geothermal ground loop, and both into the building supply line and back into the geothermal ground loop via the bridge line. The system is configured to operate in the ground loop recirculation mode when: an outdoor ambient air temperature is above the target interior air temperature range and a ground temperature of earth in which the geothermal ground loop is embedded, and the interior air temperature is above the target interior air temperature range; or the outdoor ambient air temperature is below the target interior air temperature range and the ground temperature, and the interior air temperature is below the target interior air temperature range. The system is configured to operate in a ground loop bypass mode in which air flows from the outdoor air inlet to the building supply line, and the flow control device restricts or prevents air flow into the geothermal ground loop. The system is configured to operate in the ground loop bypass mode when: the outdoor ambient air temperature is at or near the target interior air temperature range, and the interior air temperature is outside the target interior air temperature range; the interior air temperature is below the target interior air temperature range, and the outdoor ambient air temperature is: above the target interior air temperature range; and at or above the ground temperature; or the interior air temperature is above the target interior air temperature range, and the outdoor ambient air temperature is: below the target interior air temperature range; and at or below the ground temperature. Air temperature sensors for monitoring air temperature within the air ventilation system. A controller connected to operate the flow control device in response to data from the air temperature sensors. A heat exchanger is between the building return line and the building supply line. The heat exchanger comprises a heat recovery ventilator. A building recirculation line between the building return line and one or both the ground supply line and the building supply line. A second geothermal ground loop embedded in earth below the ground surface adjacent or below the building and having a second loop ground supply line and a second loop ground return line, with the second loop ground supply line connected to the building recirculation line or the ground return line downstream of the building bridge line. The geothermal ground loop comprises a serpentine conduit embedded below a foundation of the building. One or both a furnace heat exchanger and an air conditioner heat exchanger on the building supply line. Cycling air from the outdoor air inlet, through the air ventilation system, and out the exhaust air outlet. Air is cycled to flow from the outdoor air inlet through the building air ventilation system to adjust an interior air temperature of a building to a target air temperature range. Operating in a ground loop bypass mode in which air flows from the outdoor air inlet to the building air ventilation system while air flow is restricted or prevented from cycling through the geothermal ground loop.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a piping schematic illustrating an air ventilation system for a building, operated in summer, with incoming outside air being drawn in and cooled by passing the air through a geothermal ground loop and into a building ventilation circuit via a heat recovery ventilation unit (HRV).

FIG. 2 is the piping schematic of FIG. 1 operated in a recirculation/mixing mode to recirculate incoming outside air through the geothermal ground loop prior to feeding the incoming air into the building ventilation system.

FIG. 3 is the piping schematic of FIG. 1 operated in winter, with incoming outside air being drawn in and heated by passing the air through the geothermal ground loop and into a building ventilation circuit via the HRV unit.

FIG. 4 is the piping schematic of FIG. 1 operated in a bypass mode, with incoming outside air being drawn in and fed into the building ventilation system via the HRV, without passing into the geothermal ground loop.

FIG. 5 is a piping schematic illustrating an air ventilation system for a building, operating in summer to cool incoming air via the geothermal ground loop, and lacking an HRV.

FIG. 6 is the piping schematic of FIG. 5 illustrating an air ventilation system for a building, operating in summer to adjust the temperature to a desired target temperature range.

FIG. 7 is a piping schematic of the air ventilation system of FIG. 3. showing the operation of heating outside air through the geothermal ground loop.

FIG. 8 is an air ventilation system for a building, with incoming outside air being drawn in and cooled by passing the air through a geothermal ground loop and into a building ventilation circuit via an HRV.

FIG. 9 is a top plan schematic of a geothermal ground loop of an air ventilation system for a building.

FIG. 10 is a piping schematic of an air ventilation system illustrating a pair of geothermal ground loops.

### DETAILED DESCRIPTION

Immaterial modifications may be made to the embodiments described here without departing from what is covered by the claims.

Energy conservation is an important consideration for many businesses and individuals as common energy sources gradually become more expensive over time, and resources more scarce. Both heating and cooling largely contribute to the energy consumption of a building or home to maintain a comfortable temperature. As a result, alternative heating and cooling methods are becoming a greater concern for all.

Heating, ventilation, and air conditioning (HVAC) system incorporate the use of various technologies to control the temperature, humidity, freshness, and/or purity of the air in an enclosed space. A goal of an HVAC system is to provide thermal comfort and acceptable indoor air quality within an enclosed space. Common heating sources may include water, steam, air, or heat pumps. The heat generated may be distributed throughout the building or home using pipes, if using water or steam, or using ductwork systems, if using air. To cool a building, an air conditioning (AC) system uses refrigerants to remove heat from a medium such as water, air, ice and/or chemicals. A refrigerant is employed either in a heat pump system in which a compressor is used to drive thermodynamic refrigeration cycle, or in a free cooling system that uses pumps to circulate a cool refrigerant. The heating and cooling methods in an HVAC system create the optimal temperature for a home or building.

Forced air heating is the most commonly installed type of central heating in North America. A forced-air central heating system is one which uses air as its heat transfer medium. These systems rely on ductwork, vents, and plenums as means of air distribution, separate from the actual heating and air conditioning systems. The return plenum carries the air from several large return grills or vents to a central air handler for re-heating. The supply plenum directs air from the central unit to the rooms which the system is designed to heat. Regardless of type, all air handlers consist of an air filter, blower, heat exchanger, and various controls. Like most central heating systems, thermostats are used to control forced air heating systems.

Common HVAC systems have conventional furnaces and AC units installed, which require a relatively large amount of energy to adjust the building temperature to an optimal temperature. In the winter, a conventional furnace uses energy, such as from natural gas, fuel oil, or electricity, to generate heat and raise the temperature of the air, for example from about −20° C. to +20° C. In the summer, a conventional AC unit uses energy, such as from electricity, to drive a refrigeration system to draw heat from air via a heat exchanger, to cool and lower the temperature of the air, for example from about +30 or 40° C. to +20° C. Forced air systems move warm or incoming air by convection to distribute itself around the house, forcing such air into spaces within the house, and returning spent air by passive air circulation where the greater density of cooler air causes the air to sink into the furnace area below, through air return registers in the floor, and out of the house. The lesser density of warmed air causes it to rise in the ductwork, with cooling or cooler air falling into returns, and the forces of convection and passive return acting together to drive air circulation in a system termed ‘gravity-fed’. The layout of furnaces and ducting in such systems is optimized with various diameters of large ducts.

A heat recovery ventilation (HRV) system may be used to improve the energy efficiency of an HVAC system in a building. An HRV system is an energy recovery ventilation system that works between two sources at different temperatures. Heat recovery is a method that is used to reduce the heating and cooling demands of buildings. By recovering the residual heat in exhaust gas, the fresh air introduced into the air conditioning system is preheated or precooled and the fresh air enthalpy is increased or decreased before the fresh air enters the room or the air cooler of the air conditioning unit performs heat and moisture treatment. A typical heat recovery system in buildings comprises a core unit, channels for fresh and exhaust air, and blower fans. Building exhaust air is used as either a heat source or heat sink depending on climate conditions, time of year and requirements of the building. Heat recovery systems typically recover about 60-95% of the heat in exhaust air and have significantly improved the energy efficiency of buildings.

Geothermal heating is the direct use of geothermal energy for heating applications. Humans have taken advantage of geothermal heat this way since the Paleolithic era. Thermal efficiency is high since no energy conversion is needed, but capacity factors tend to be low (around 20%) since the heat is mostly needed in the winter. Geothermal energy originates from heat retained within the Earth, whether from radioactive decay of minerals, or from solar energy absorbed at the surface. Most high temperature geothermal heat is harvested in regions close to tectonic plate boundaries where volcanic activity rises close to the surface of the Earth. In these areas, ground and groundwater can be found with temperatures higher than the target temperature of the application. However, even relatively cold ground contains heat energy. Below 6 meters (20 ft), the undisturbed ground temperature is consistently at the mean annual air temperature, and this heat can be extracted with a ground source heat pump.

In regions without any high temperature geothermal resources, a ground-source heat pump (GSHP) can provide space heating and space cooling. Like a refrigerator or air conditioner, these systems use a heat pump to force the transfer of heat from the ground to the building. Heat can theoretically be extracted from any source, no matter how cold, but a warmer source allows for higher efficiency. A ground-source heat pump uses the shallow ground or ground water (typically starting at 10-12° C. or 50-54° F.) as a source of heat, thus taking advantage of its seasonally moderate temperatures, to heat cold air in winter, and cool warm air in summer. In contrast, an air source heat pump draws heat from the air (colder outside air) and thus requires more energy.

GSHPs may commonly circulate a carrier fluid (usually a mixture of water and small amounts of antifreeze) through closed pipe loops buried in the ground. Single-home systems may be “vertical loop field” systems with bore holes 50-400 feet (15-120 m) deep or, if adequate land is available for extensive trenches, a “horizontal loop field” may be installed approximately six feet subsurface. As the fluid circulates underground it absorbs heat from the ground and, on its return, the warmed fluid passes through the heat pump which uses electricity to extract heat from the fluid. The re-chilled fluid is sent back into the ground thus continuing the cycle. The heat extracted and that generated by the heat pump appliance as a byproduct is used to heat the house. The addition of the ground heating loop in the energy equation means that significantly more heat can be transferred to a building than if electricity alone had been used directly for heating.

Switching the direction of heat flow, the same system may be used to circulate the cooled water through the house for cooling in the summer months. The heat is exhausted to the relatively cooler ground (or groundwater) rather than delivering it to the hot outside air as an air conditioner does. As a result, the heat is pumped across a larger temperature difference and this leads to higher efficiency and lower energy use. This technology makes ground source heating economically viable in any geographical location. In 2004, an estimated million ground-source heat pumps with a total capacity of 15 GW extracted 88 PJ of heat energy for space heating. Global ground-source heat pump capacity is growing by 10% annually.

A geothermal heat pump is a heating/cooling system for buildings that uses a type of heat pump to transfer heat to or from the ground, taking advantage of the relative constancy of temperatures of the earth through the seasons. Ground source heat pumps are among the most energy-efficient technologies for providing heating, ventilation, and air conditioning (HVAC) and water heating, using far less energy than can be achieved by burning a fuel in a boiler/furnace or by use of resistive electric heaters.

Conventional geothermal heat pump systems may comprise a heat exchange unit that is in fluid communication with a loop of tubing buried in the ground, commonly referred to as a ground loop. A heat-exchange fluid, such as a water/ethylene glycol mixture, may be circulated through the ground loop, during which heat is exchanged between the earth proximate the ground loop and the heat exchange fluid. When the heat exchange fluid returns to the heat exchange unit after having circulated through the ground loop, the temperature difference between the heat exchange fluid being fed to the ground loop and the heat exchange fluid returning from the ground loop is used by the heat exchange unit to generate either heated or cooled air, using a refrigerant. This heated or cooled air is then pumped into the interior of a building structure to control its internal climate.

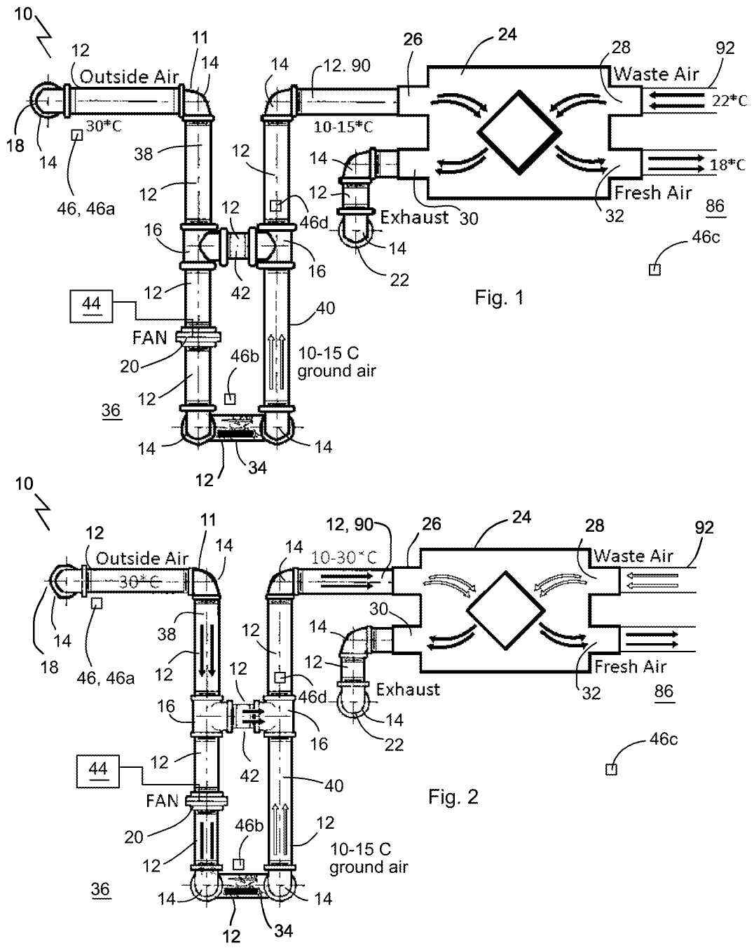

Referring to FIGS. 1, 8 and 9, an air ventilation system 10 for geothermal heating and cooling of an interior 86 of a building 70 is disclosed. The air ventilation system 10 may define an outdoor air inlet 18, which may allow for the intake of fresh air into the system 10. The air ventilation system 10 may comprise a geothermal ground loop 34, which may be embedded in earth below a surface of a ground 36 adjacent or below the building 70. The loop 34 may have or define a ground supply line 38 and a ground return line 40. The air ventilation system 10 may define a building supply line 90, which may be connected to the ground return line 40. The building supply line 90 may be configured to distribute air throughout the interior 86 of the building 70. The air ventilation system 10 may comprise a building return line 92, which may be configured to return air from the building 70. The air ventilation system 10 may define an exhaust air outlet 22, which may be connected to exhaust air from the building return line 92. In use, air may be supplied from the outdoor air inlet 18, circulated through the building 70, and exhausted from air outlet 22 after the air passes through the building 7.

Referring to FIGS. 1-8, the air ventilation system 10 may comprise piping 11. Piping 11 may be made up of various suitable components, such as air ducts, which may be connected through the use of appropriate fittings such as elbows fittings 14, straight ducts 12, and tee fittings 16. The air in the air ventilation system 10 may enter the system 10 through the outdoor air inlet 18. The outdoor air inlet 18 may be connected to a ground supply line 38 of the ground loop 34 through the use of a ducting connector, for example an elbow fitting 14, or any other suitable method of connection which allows the movement of air. The ground supply line 38 may be connected to the ground loop 34 of the system 10 through the use of a ducting connector, for example an elbow fitting 14, tee fitting 16, or any other suitable method of connection which allows the movement of air. The air within the ground loop 34 may exit the loop 34 through a ground return line 40, which may be connected to the ground loop 34 through the use of a suitable ducting connector, for example elbow fitting 14. The air may pass through the ground return line 40 to the building supply line 90, which may be connected to the ground return line 40 through the use of a suitable ducting connector, for example elbow fitting 14. The building supply line 90 may be connected to a heat recovery ventilator (HRV) 24 in order to allow air to pass from the building supply line 90 to the HRV 24, the building supply line 90 may be connected to the HRV 24 through the use of a suitable ducting connector, for example an outside air duct.

Referring to FIGS. 1, 8, and 9, the geothermal ground loop 34 may be positioned below the ground 36 and have suitable features. The loop 34 may be buried a suitable distance below the surface of the ground 36, such as six to twenty-five feet or more. The geothermal ground loop 34 may comprises a serpentine conduit. The loop 34 may have a suitable length and inner dimensions, for example between one hundred and five hundred feet long (for example two hundred feet long), with an average inner diameter of three to twelve inches (for example six inches), or other dimensions to reduce pressure loss while increasing surface area and exposure to heat exchange with the adjacent ground 36. The ground loop 34 may be embedded adjacent or below a foundation 88 of the building 70, where the air in the ground loop 34 may be either heated or cooled. The air may move through the ground return line 40 and the building supply line 90 to an HRV 24, which may be located in a suitable spot in the building 70, for example, in the basement 72 of the building 70. In other cases, the ground loop 34 feeds directly into the building without passing through an HRV 24. A manifold, such as formed by fittings 16 of piping 11, may feed both a building air ventilation system (building supply line 90) and geothermal ground loop 34.

Referring to FIGS. 1-7, the air ventilation system 10 may be configured to circulate air to enter, bypass, or enter and bypass the geothermal ground loop 34 prior to entering the building air ventilation system. The system 10 may comprise a bridge line 42 between the ground supply line 38 and the ground return line 40. The line 42, ground supply line 38 and ground return line 40 may collectively form a manifold. The manifold may have a suitable structure, such as a pair of tee fittings 16, which may allow the bridge line 42 to couple to the ground supply line 38 and the ground return line 40. In use, air may be supplied from the outdoor air inlet 18 to the manifold and the bridge line 42, as the system 10 is operated in a recirculation mode where recirculation of air is permitted through the geothermal ground loop and into the building air ventilation system. The air bridge line 42 may feed both the building supply line 90 and the geothermal ground loop 34, and thus may permit both recirculation and bypass.

Referring to FIGS. 1-8, the air ventilation system 10 may comprise a flow control device. The flow control device may be located in the piping 11 of the system 10. The flow control device may comprise a fan 20. In some cases, there may be more than one flow control device, for example one or more fans, baffles, valves, or other devices. A fan 20 may act to adjust pressure in the system 10 to adjust and direct flow of air. In some cases, a fan may be used to increase or decrease the amount of air entering the system 10 through the outdoor air inlet 18. An increase in the speed of the fan 20 may result in an increase of air intake to the system 10, while a decrease in the speed of the fan 20 may result in a decrease of air intake to the system 10. A flow control device, such as fan 20 may be located on the ground supply line 38 at a suitable location. The bridge line 42 may be connected to the ground supply line 38 between the flow control device, for example the fan 20, and the outdoor air inlet 18. The fan 20 may be used to divert air into the ground loop 34, for example in a normal operating mode or in a recirculation mode. The fan 20 may be used to divert air away from the ground loop 34, for example in a ground loop bypass mode. In some cases, the speed and direction of the fan 20 may be adjusted to tailor the effect of the fan 20, for example to increase or decrease the ratio of incoming air passing into the ground loop 34 versus the bridge line 42 (and hence into the building supply line 90).

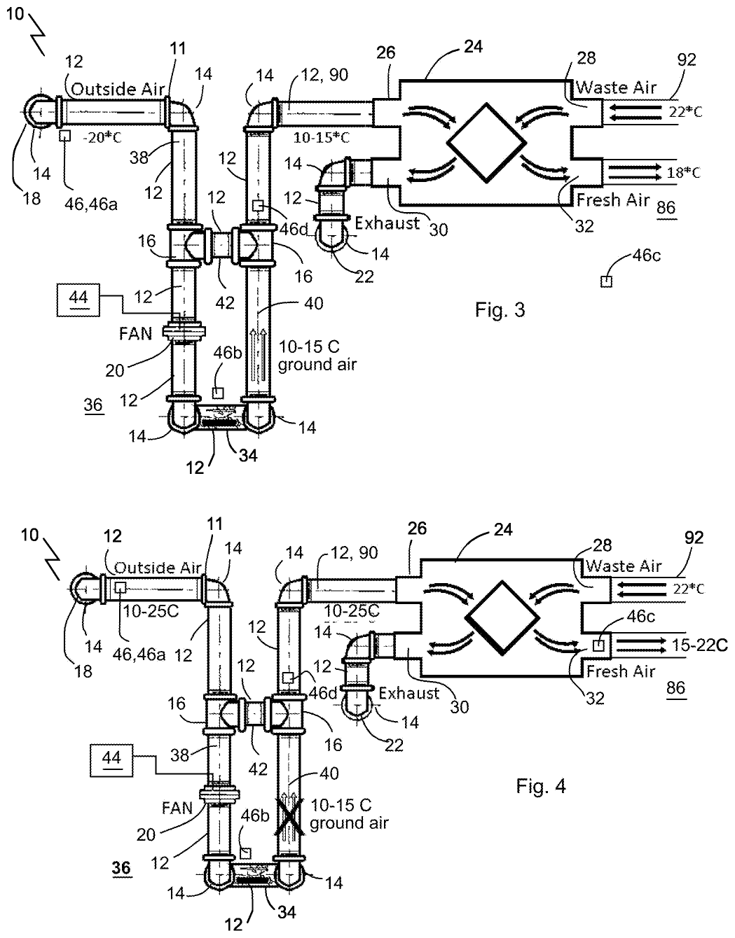

Referring to FIG. 1, the air ventilation system 10 may be configured to recirculate incoming air through more than one pass through the geothermal ground loop 34. The system 10 may be configured to operate in a ground recirculation mode in certain circumstances. In the ground recirculation mode, the flow control device, such as the fan 20, may permit air to flow from the outdoor air inlet 18, through the geothermal ground loop 34, and both into the building supply line 90 and back into the geothermal ground loop 34 via the bridge line 42. By recirculating air in the ground loop 34 before providing such air to the building 70, the temperature of air incoming to the building supply line 90 may be brought closer into equilibrium with the temperature of the ground 36. For example, referring to FIG. 1, in summer, on a first pass through loop 34, incoming air may change from an outdoor temperature of 30° C. to a temperature of 22° C., and on a second pass through loop 34 the temperature may drop to 15° C. For further example, referring to FIG. 3, in winter, on a first pass through loop 34, incoming air may change from an outdoor temperature of −20° C. to a temperature of 7° C., and on a second pass through loop 34 the temperature may rise to 15° C. Recirculation may be useful to address relatively large differences between a target air temperature range in the building 70 and an outdoor ambient air temperature, for example when such difference is 20° C. or greater or smaller. Thus, recirculation may provide additional cooling or heating as the case may be and as needed.

Referring to FIG. 1, the air ventilation system 10 may be configured to cycle air to flow from the outdoor air inlet 18 through the system 10 to adjust an interior air temperature of a building 70 to a target air temperature range. A target air temperature range may effectively be a single temperature, or may span a range of temperatures, the size of which may be selected by the user and/or set by the system 10. The air ventilation system 10 may comprise a plurality of air temperature sensors 46. The air temperature sensors 46 may be used for monitoring air temperature within the air ventilation system 10. Temperature sensors 46, such as an outdoor air temperature sensor 46A, a ground loop 34 temperature sensor 46B, an interior temperature sensor 46C, and a building supply line temperature sensor 46D may be used to detect temperatures. In some cases, temperature sensors may be mounted within piping 11, and in other cases may be mounted external to piping 11. A controller 44 may be connected to receive temperature data, and user-defined operational parameters, in order to configure how the system 10 will operate. A controller 44 may be connected to operate the flow control device, such as the fan 20, in response to data from the air temperature sensors 46 and the predetermined interior air temperature. Depending on the data received from the air temperature sensors 46, the controller 44 may activate the flow control device, such as the fan 20, to either operate in a ground recirculation mode, in a ground loop bypass mode, or in other various modes.

Referring to FIGS. 1-7, the system 10 may cycle air from the outdoor air inlet 18, through the air ventilation system 10, and out the exhaust air outlet 22. Air may be cycled to flow from the outdoor air inlet 18 through the building air ventilation system to adjust an interior air temperature (for example detected by sensor 46C) of a building 70 to a target air temperature range. In some cases, the system 10 may cycle between various primary modes, for example a no-flow or no-heating-or-cooling flow mode (when the system 10 is off or the indoor air temperature is within the target interior air temperature range), an air conditioning (cooling) mode where the interior air temperature is above a target interior air temperature range, and a heating mode where the interior air temperature is below a target interior air temperature range. In some cases, the system 10 may adjust each primary mode to operate within a secondary mode, such as a basic ground loop mode, a recirculation mode, and a bypass mode. In the basic ground loop mode, the system 10 may pass most or all of the incoming air into the ground loop 34. In the recirculation mode, the system 10 may pass at least some of the incoming air through the ground loop 34 more than once prior to entering the building ventilation system. In the bypass mode, at least some, for example most, of the incoming air, bypasses the ground loop 34.

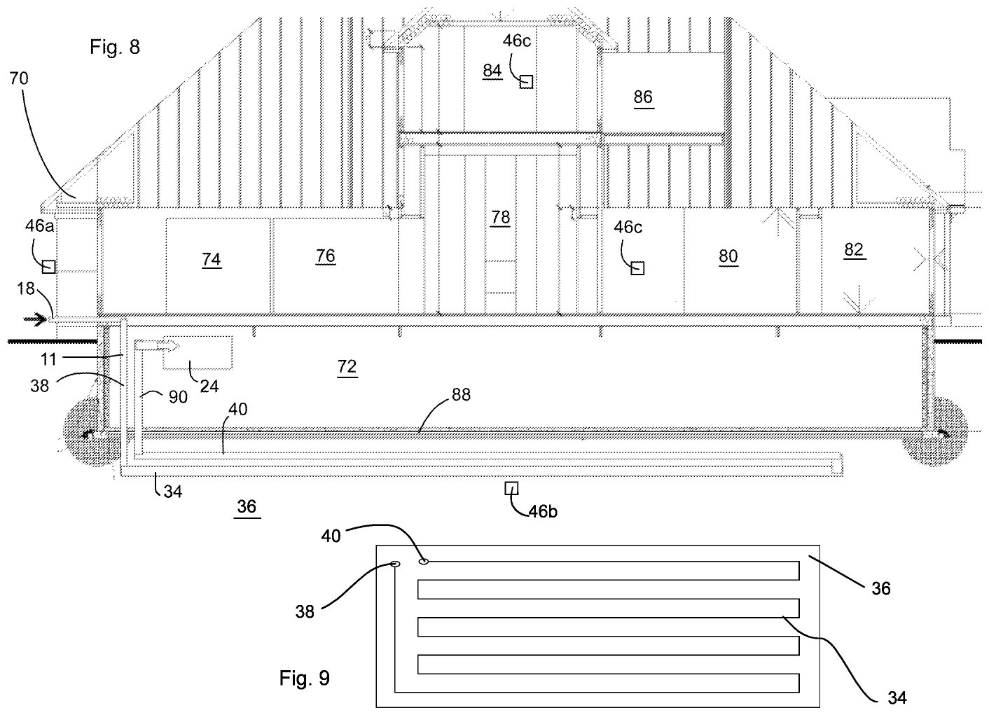

Referring to FIG. 8, an example is shown with system 10 installed in a standard building 70, such as a house. The building 70 may include various standard aspects, such as a basement 72, a kitchen 74, a dining room 76, a master suite 80, and ensuite 82 or other bathrooms, a bonus room or bedroom 84, and other features within the interior 86 of the building 70. The building 70 interior 86 may be heated and cooled by an HVAC system such as a force air system as shown complete with heat registers for return and supply, and ducting therebetween. The ground loop 34 may be located below the building 70, for example below the foundation 88. An HRV 24 may be installed in the basement as discussed elsewhere.

Referring to FIGS. 1 and 3, as above the system 10 may be configured to operate in a ground recirculation mode in certain circumstances. Referring to FIG. 1, air ventilation system 10 may be configured to operate in the ground recirculation mode when an outdoor ambient air temperature (for example detected by sensor 46A) is above a target interior air temperature range, and a ground temperature (for example detected by sensor 46B) of earth (ground 36) in which the geothermal ground loop 34 is embedded in. Such a mode may be operated in summer or at other appropriate times depending on sensor data and operational parameters. The recirculation mode may be initiated when the interior air temperature (for example detected by sensor 46C) is above the target interior air temperature, indicating that the user wishes the interior air temperature to be reduced in the building 70. In some cases, the system 10 may modulate the amount of recirculation, for example from full bypass (no air goes into the ground loop 34, to no recirculation (up to one cycle through ground loop 34 for incoming air) to full recirculation (two or more cycles through ground loop 34 for incoming air). In some further cases, recirculation may occur to achieve two, three, four, or more passes of the same air through the loop 34 prior to entering the building ventilation system. Recirculation may be assisted by valving or other flow control devices at suitable locations, such as downstream of bridge line 42 on building supply line 90, for example to temporarily restrict or prevent flow into the building ventilation system 10 until the desired pre-cooling or pre-heating of incoming air is achieved. Allowing the air to recirculate through the bridge line 42 in such cases will allow the thermal energy of the air to be lower when it enters the building 70 than if the air was not recirculated through the geothermal ground loop 34. In some cases, for example depending on the difference between the target interior air temperature and the interior air temperature, the system 10 may at least partially bypass the ground loop 34.

Referring to FIG. 3, air ventilation system 10 may be configured to operate in the ground recirculation mode during relatively cooler outdoor temperatures. For example, the air ventilation system 10 may be configured to operate in the ground recirculation mode when the outdoor ambient air temperature is below both the target interior air temperature range and the ground temperature of earth in which the geothermal ground loop 34 is embedded in. Such a mode may be operated in winter or at other appropriate times depending on sensor data and operational parameters. In these cases, the recirculation mode may be initiated when the interior air temperature (for example detected by sensor 46C) is below the target interior air temperature, indicating that the user wishes the interior air temperature to be increased in the building 70. Allowing the air to recirculate through the bridge line 42 in such cases will allow the thermal energy of the air to be higher when it enters the building 70 than if the air was not recirculated through the geothermal ground loop 34.

Referring to FIG. 4, as above, the air ventilation system 10 may be configured to at least partially bypass the geothermal ground loop 34. The system 10 may be configured to operate in a ground loop bypass mode in which air flows from the outdoor air inlet 18 to the building supply line 90, for example via the bridge line 42, and the flow control device, such as the fan 20, restricts or prevents air flow into the geothermal ground loop 34. The ground loop bypass mode may be used when the temperature of the incoming air does not need to be changed at all or substantially to achieve the desired cooling or heating, for example when the outdoor ambient air temperature is at or near the target interior air temperature range. In some cases, flow may occur when the interior air temperature is outside the target interior air temperature range, although in other cases flow may occur even when the interior air temperature is within the target interior air temperature range for circulation purposes.

Referring to FIG. 4, the air ventilation system 10 may be configured to operate in the ground loop bypass mode in various situations. For example, the bypass mode may be operated when the interior air temperature is below the target interior air temperature range. In such cases, the bypass mode may be operated when the outdoor ambient air temperature is above the target interior air temperature range, and at or above the ground temperature. In some cases, the bypass mode may be operated when the interior air temperature is above the target interior air temperature range, and the outdoor ambient air temperature is below the target interior air temperature range, and at or below the ground temperature. In such cases, there may be no need to supply incoming air to the ground loop 34, as such is unnecessary and less efficient than bypassing the loop 34. In the example shown in FIG. 4, the outdoor air temperature is similar to the temperature of the ground 36 adjacent the ground loop 34, and thus there is relatively no need to circulate incoming air into the ground loop 34.

Referring to FIGS. 1-7 the system 10 may incorporate a heat exchanger. A heat exchanger may be located at a suitable point in the system 10, for example between the building return line 92 and the building supply line 90. One example of a heat exchanger is an HRV 24. Incoming air may move independently and in isolation through the ground return line 40 and the building supply line 90 within the HRV 24, exchanging heat between one another, in an effort to recover heat or cool incoming air using outgoing air from the building 70. Referring to FIG. 8, an HRV may be located in a suitable spot in the building 70, for example, in the basement 72 of the building 70. Referring to FIGS. 1-7, an HRV 24 may have a suitable housing within an internal heat exchanger. Incoming air may travel via the building supply line 90, into the HRV 24 via an inlet 26, travel in isolation through the heat exchanger to exchange heat with outgoing air without mixing with such air, exiting the HRV 24 via an outlet 32, where the air then enters circulation within the building 70 ventilation system. By contrast, outgoing air may travel into the HRV 24 via an inlet 28, travel in isolation through the heat exchanger to exchange heat with incoming air without mixing with such air, exiting the HRV 24 via an outlet 30, travelling to the air outlet 22, where the air then exits the building 70 into the ambient environment. The purpose of an HRV 24 is to transfer thermal energy between the air being exhausted and the air being supplied to the building 70. There may be no direct interaction (i.e., mixing) between the exhausted air and the supplied air, and the thermal energy may be transferred through the use of the heat exchanger. Referring to FIGS. 1 and 3, an HRV 24 may be useful as both a second stage conditioner (with the first stage being the ground loop 34 or bypass of same), where the first stage adjusts the temperature of the incoming air partway toward the target interior air temperature, and the second stage performs a finer adjustment of the temperature of the post-first stage incoming air toward the target interior air temperature using heat exchange with outgoing air from the building 70. Referring to FIG. 1, in one example in summer, incoming air at 30° C. is adjusted in the ground loop 34 (first stage) to about 10-15° C., and then adjusted further within the HRV 24 to about 18° C. by heat exchange with 22° C. interior air from the building. Referring to FIG. 3, in one example in winter, incoming air at −20° C. is adjusted in the ground loop 34 (first stage) to about 10-15° C., and then adjusted further within the HRV 24 to about 18° C. by heat exchange with 22° C. interior air from the building.

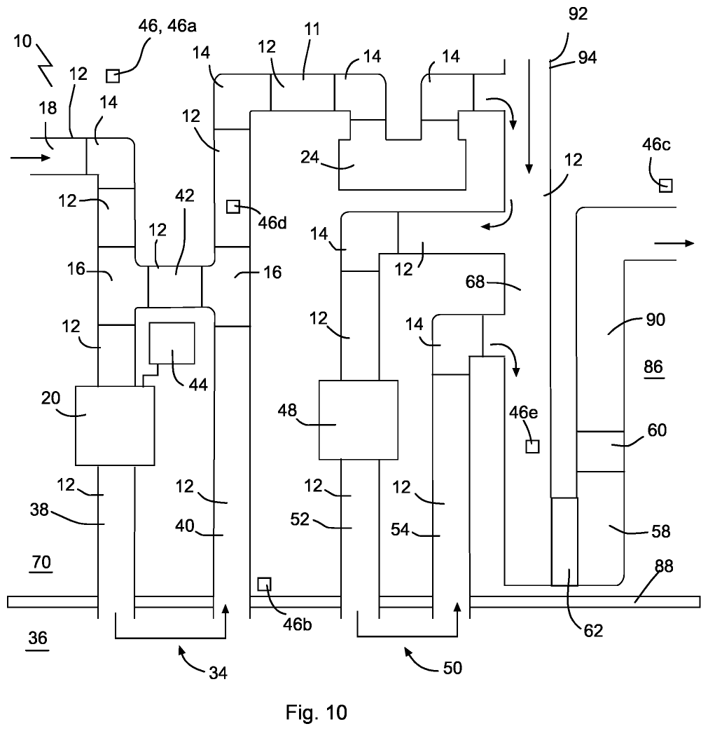

Referring to FIG. 10, the system 10 may incorporate building exhaust air recirculation. In the example shown, a building recirculation line 94 is between the building return line 92 and the building supply line 90. Such a configuration may allow exhaust air to recirculate through the building 70, with or without mixing with fresh air from the building supply line 90 and air inlet 18. Some level of mixing may be required in certain cases to ensure that air entering the building ventilation system is fresh enough for the occupants of the building 70 to breathe. A flow control device or devices may be used to manipulate and adjust such mixing and proportioning of incoming and exhaust flows. One or more flow control devices (not shown) may be present upstream of line 94 to control the degree of recirculation, for example from 0% (all exhaust air from building return line 92 is exhausted to the outdoors) to 100% (all exhaust air from building return line 92 is recirculated back into the building ventilation system). By recirculating air within the building 70, the heat energy inherent in the circulated interior air is retained, improving heating and cooling efficiency.

Referring to FIG. 10, the system 10 may incorporate one or both building exhaust air recirculation and a second ground loop. A second geothermal ground loop 50 may be embedded in earth below the surface of the ground 36 adjacent or below the building 70. The second loop 50 may have a second loop ground supply line 52 and a second loop ground return line 54. The second loop ground supply line 52 may be connected to the building recirculation line 94 or the ground return line 40 downstream of the building bridge line 42. The second loop 50 may be run in series with loop 34, or in parallel as shown. In some cases, the second loop 50 may be used with our without recirculation of building exhaust air back into the building ventilation system as shown. A flow control device such as a fan 48 may control flow into the second loop 50. A temperature sensor 46E may be present on the line 94 to detect the air temperature of air exiting the second loop 50 and mixing with incoming air. A second loop bridge line 68 may be present to bypass the second loop 50. In some cases, the recirculation line 94 may be connected to the ground supply line 38 of the first ground loop 34. As in all embodiments, incoming air may pass through additional features of the system 10, such as a subsequent heating or cooling stage provided by a furnace 58 (furnace heat exchanger, with a filter 62 shown in the example as well), and an air conditioner unit 60 (air conditioning heat exchanger, such as a condenser coil connected by coolant lines to an AC unit (not shown).

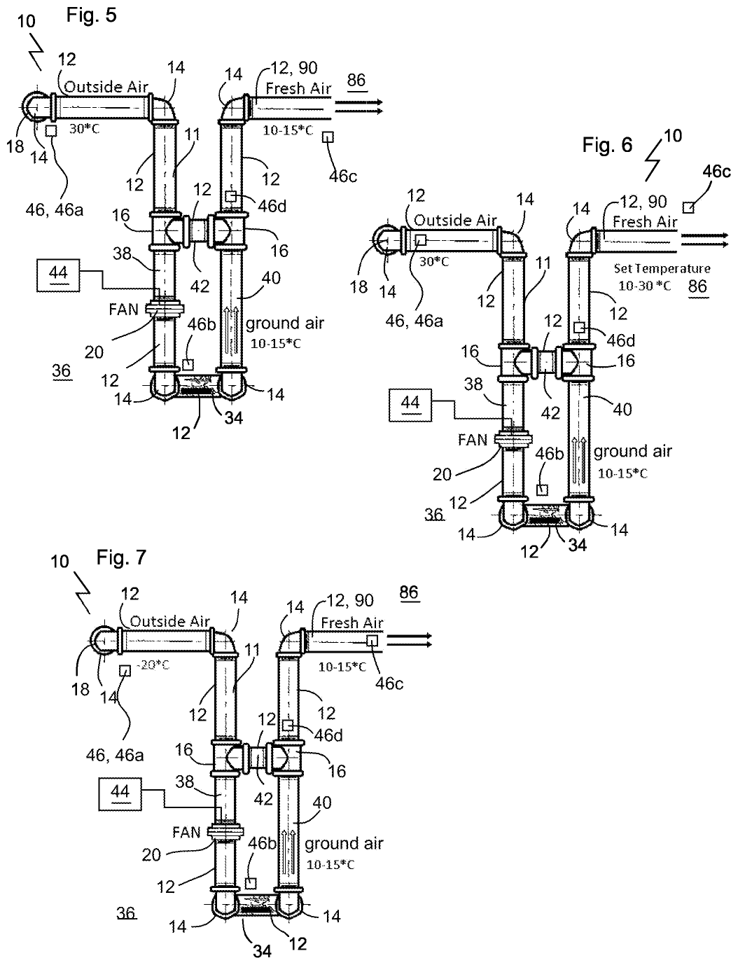

Referring to FIGS. 1-7, the air ventilation system 10 maybe be configured to operate in different modes depending on the temperature of the outside air, the temperature of the ground in which the geothermal ground loop is embedded in, the interior air temperature, and the target interior air temperature. The system 10 may be initiated to heat or cool incoming air when the interior air temperature moves outside the target air temperature range (which may be set by a user operating a control panel, such as controller 44, to adjust heating and cooling settings). Referring to FIG. 1, in the example shown, the system 10 is operated in summer in a standard mode to circulate incoming air through ground loop 34, HRV 24, and into the building ventilation system 10. Referring to FIG. 2, a similar example as FIG. 1 is illustrated, except that a degree of bypass is permitted (bypass mode), whereby incoming air is permitted to flow through bridge line 42 and ground loop 34, in order to achieve a desired target interior air temperature. Referring to FIG. 3, in the example shown, the system 10 is operated in winter in a standard mode to circulate incoming air through ground loop 34, HRV 24, and into the building ventilation system 10. Referring to FIG. 4, in the example shown, the system 10 is operated in fall or a relatively milder day of the year in a bypass mode to circulate incoming air through HRV 24 (excluding ground loop 34), and into the building ventilation system 10. Referring to FIG. 5, an example similar to FIG. 1 is illustrated except with the system 10 lacking an HRV 24. Referring to FIG. 6, an example similar to FIG. 5 is illustrated except with the system 10 incorporating temperature sensors 46 within piping 11. Referring to FIG. 7, an example similar to FIG. 3 is illustrated except with the system 10 lacking an HRV 24.

In some cases, the system 10 may function as near or true net zero energy system. The system 10 may significantly reduce summer air conditioning consumption and may lower winter heating costs, by using geothermal heating or cooling to reduce the gap between outdoor ambient air temperature and target interior air temperature. In the example of FIG. 3 alone, the use of loop 34 may adjust −20° C. outdoor air to 10-15° C. prior to furnace operation, reducing the outputs requirements and energy use of the furnace. An electric heater may be used near the furnace as a primary heater, with a gas furnace as a secondary heater. Secondary heat may be used as an emergency if the electric heat is unable to sufficiently heat the air. Solar power may be used to power the electric heater. The system 10 may heat and store hot water throughout the day and use it to heat the air when needed. Internal heat sources such as body heat and electronic devices could potentially add enough heat to make the house self-sufficient. The benefit may be that no natural gas would be burned in the building 70, which may make the building 70 it a true zero emission house. The electricity gained in the summer may be sold back to the grid, and the money gained may be used to buy back power in the winter. Other benefits of the system may include reduced winter heating requirements (up to 75%), the building 70 may not require heating with occupants and good insulation, natural way of cooling the house and the system 10 won't work against itself in spring or fall.

The ground loop systems disclosed were developed to investigate the feasibility of a ground loop to transfer heat to and from the surrounding earth in a passive heat exchange process to eliminate the changing temperature throughout the seasons. The system may be aimed at providing 10-18° C. intake air regardless of external temperature. The system may take intake air from the outside and runs it thru buried tubing. The ground temperature was approximately 13ºC when testing. 23° C. air was passed through the systems and the system consistently cooled such air to 15° C. During the extreme winter the outside temperature of −40° C. would be heated to approximately 10° C. when going through this system. The remaining 10° C. needed to heat it to room temperature represents only ⅙th the total energy requirements. An energy savings of about 80% on heating can be achieved. The colder the climate gets in winter the more efficient the system would be. The average temperature in December 2021 was −20° C. in the area tested. The system would be able to reduce about 75% of the heating bill in that month. When external temperatures reach above 21° C. in summer the system will take in fresh air at a 15° ° C. which can be used to cool the house. If the intake air is too cold after this process a mixing system can be used to regulate the temperature to a more comfortable level. An HRV may be used in addition to this system to regain even more energy. The system works well when external temperatures are well below ground temperature (10° C.) or above comfortable room temperature (23° C.). In the range between 10° C. and 23° C. it may be counterproductive but to a small degree, for example 18° C. intake air being cooled to 15° C. which would result in more heating required. During this operation mode, the system should bypass and not use the ground loop. A simple programmable logic controller may be used to monitor intake and ground temperature sufficiently. The heat that is absorbed during the summer with this system may be released in the winter. Over time the ground temperature may drift and more experimentation over years is required to establish a seasonal cycle. Ideally, the heat stored in summer will equal the heat released in winter and the system is stable.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. An air ventilation system for geothermal heating and cooling of an interior of a building, the system comprising piping that includes:
an outdoor air inlet;
a geothermal ground loop embedded in earth below a ground surface adjacent or below the building and having a ground supply line and a ground return line;
a flow control device in the piping;
a bridge line between the ground supply line and the ground return line;
a building supply line connected to the ground return line and configured to distribute air throughout the interior of the building;
a building return line configured to return air from the building; and
an exhaust air outlet connected to exhaust air from the building return line.

2. The air ventilation system of claim 1 in which the flow control device comprises a fan.

3. The air ventilation system of claim 2 in which the flow control device is on the ground supply line.

4. The air ventilation system of claim 3 in which the bridge line connects to the ground supply line between the flow control device and the outdoor air inlet.

5. The air ventilation system of claim 1 in which the bridge line, ground supply line, and ground return line form a manifold.

6. The air ventilation system of claim 1 configured to cycle air to flow from the outdoor air inlet through the system to adjust an interior air temperature of a building to a target air temperature range.

7. The air ventilation system of claim 6 configured to operate in a ground loop recirculation mode in which the flow control device permits air to flow:
from the outdoor air inlet,
through the geothermal ground loop, and
both into the building supply line and back into the geothermal ground loop via the bridge line.

8. The air ventilation system of claim 7 configured to operate in the ground loop recirculation mode when:
an outdoor ambient air temperature is above the target interior air temperature range and a ground temperature of earth in which the geothermal ground loop is embedded, and the interior air temperature is above the target interior air temperature range; or
the outdoor ambient air temperature is below the target interior air temperature range and the ground temperature, and the interior air temperature is below the target interior air temperature range.

9. The air ventilation system of claim 7 configured to operate in a ground loop bypass mode in which air flows from the outdoor air inlet to the building supply line, and the flow control device restricts or prevents air flow into the geothermal ground loop.

10. The air ventilation system of claim 9 configured to operate in the ground loop bypass mode when:
the outdoor ambient air temperature is at or near the target interior air temperature range, and the interior air temperature is outside the target interior air temperature range;
the interior air temperature is below the target interior air temperature range, and the outdoor ambient air temperature is:
above the target interior air temperature range; and
at or above the ground temperature;
or the interior air temperature is above the target interior air temperature range, and the outdoor ambient air temperature is:
below the target interior air temperature range; and
at or below the ground temperature.

11. The air ventilation system of claim 1 further comprising:
air temperature sensors for monitoring air temperature within the air ventilation system; and
a controller connected to operate the flow control device in response to data from the air temperature sensors.

12. The air ventilation system of claim 1 in which the heat exchanger comprises a heat recovery ventilator.

13. The air ventilation system of claim 1 further comprising a building recirculation line between the building return line and one or both the ground supply line and the building supply line.

14. The air ventilation system of claim 13 further comprising a second geothermal ground loop embedded in earth below the ground surface adjacent or below the building and having a second loop ground supply line and a second loop ground return line, with the second loop ground supply line connected to the building recirculation line or the ground return line downstream of the building bridge line.

15. The air ventilation system of claim 1 in which the geothermal ground loop comprises a serpentine conduit embedded below a foundation of the building.

16. The air ventilation system of claim 1 further comprising one or both a furnace heat exchanger and an air conditioner heat exchanger on the building supply line.

17. A method comprising cycling air from the outdoor air inlet, through the air ventilation system of claim 1, and out the exhaust air outlet.

18. A method comprising:
supplying air from an outdoor air inlet to a manifold that feeds both a building air ventilation system and a geothermal ground loop;
operating in a ground recirculation mode where recirculation of air is permitted through the geothermal ground loop and into the building air ventilation system; and
exhausting air from the building air ventilation system after the air passes through the building.

19. The method of claim 18 in which air is cycled to flow from the outdoor air inlet through the building air ventilation system to adjust an interior air temperature of a building to a target air temperature range.

20. The method of claim 19 further comprising:
operating in a ground loop bypass mode in which air flows from the outdoor air inlet to the building air ventilation system while air flow is restricted or prevented from cycling through the geothermal ground loop.
